(19) United States
(12) Patent Application Publication
(10) Pub. No.: US 2005/0213616 A1
(43) Pub. Date: Sep. 29, 2005

(54) Fiber laser device

(75) Inventors: Nobuaki Kaji, Kanagawa (JP); Masaki Tsuchida, Tokyo (JP); Ko Sato, Tokyo (JP); Hideaki Okano, Kanagawa (JP); Ken Ito, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/087,770

(22) Filed: Mar. 24, 2005

(30) Foreign Application Priority Data
Mar. 24, 2004 (JP) 2004/87887

(51) Int. Cl. H01S 3/30

(52) U.S. Cl. 372/6

(57) ABSTRACT

A fiber laser device contains a first optical fiber of a double-clad type in which optical resonance of an infrared laser light takes place inside a core with Pr³⁺and Yb³⁺added thereto to generate a light of a wavelength of about 630 nm, a second optical fiber of a double-clad type in which optical resonance of an infrared laser light takes place inside a core with Pr³⁺and Yb³⁺added thereto to generate a light of a wavelength of about 690 nm, and a third optical fiber in which optical resonance of the lights from the first and second optical fibers takes place inside a core with Tm³⁺added thereto to generate a light of a wavelength of about 450 nm, and the core diameter of the third optical fiber is made substantially equal to the spot diameters of the lights from the first and second optical fibers.

### CROSS-REFERENCE TO RELATED APPLICATIONS

This application is based upon and claims the benefit of priority from the prior Japanese Patent Application No. 2004-87887, filed on Mar. 24, 2004; the entire contents of which are incorporated herein by reference.

### BACKGROUND OF THE INVENTION

1. Field of the Invention

The present invention relates to a fiber laser device having a semiconductor laser element used as an excitation light source and for obtaining a blue laser light of a wavelength of about 450 nm.

2. Description of the Related Art

In recent years, it can be considered that a laser light of a blue wavelength is utilized in a wide area of projection-type image display devices, optical storage devices, optical information processing units, and others.

As a laser device generating a laser light of a blue wavelength, there is an upconversion laser device proposed in Japanese Unexamined Patent Application Publication No. 2001-203412 (hereinafter, referred to as the document), for example. In a fiber laser device in FIG. 10 showing an eighth embodiment in the document, an excitation infrared light output from a semiconductor laser is radiated into an optical fiber having a core in which rare-earth ions of praseodymium ion (Pr³⁺) and ytterbium ion (Yb³⁺) are added thereto. A laser light of a wavelength of about 630 nm and a laser light of a wavelength of about 690 nm are oscillated by utilizing upconversion of an optical fiber having rare-earth ions added thereto. A blue laser light of a wavelength of about 450 nm is obtained such that the laser lights of two wavelengths are synthesized by using a wavelength synthesizer and radiated into an optical fiber having a core in which a rare-earth ion of thulium ion (Tm³⁺) is added.

In the fiber laser device shown in FIG. 10 in the document, the construction of the optical fiber in which the laser light of a wavelength of about 630 nm and the laser light of a wavelength of about 690 nm are oscillated is not clearly described. However, generally, the use of a single-clad fiber can be considered.

That is, in an example generating a laser light of a wavelength of about 630 nm, an optical resonator is formed such that a first optical fiber is composed of a core having praseodymium ion (Pr³⁺) and ytterbium ion (Yb³⁺) added thereto and a clad provided around the core and that reflective elements are disposed on the incident and radiant end faces of the first optical fiber. An infrared laser light emitted from a first semiconductor laser is radiated into the first optical fiber and excites. The excitation light radiated into the first optical fiber is absorbed by the praseodymium ion (Pr³⁺) and ytterbium ion (Yb³⁺) added to the core and optical resonance takes place due to the reflective elements provided at both end faces of the first optical fiber to generate a laser light of a wavelength of about 630 nm.

Furthermore, in an example generating a laser light of a wavelength of about 690 nm, an optical resonator is formed such that a second optical fiber is composed of a core having praseodymium ion (Pr³⁺) and ytterbium ion (Yb³⁺) added thereto and a clad provided around the core and that reflective elements are disposed on the incident and radiant end faces of the second optical fiber. An infrared laser light emitted from a second semiconductor laser is radiated into the second optical fiber and excites. The excitation light radiated into the second optical fiber is absorbed by the praseodymium ion (Pr³⁺) and ytterbium ion (Yb³⁺) added to the core and optical resonance takes place due to the reflective elements provided at both end faces of the second optical fiber to generate a laser light of a wavelength of about 690 nm.

Moreover, when the laser lights of wavelengths of about 630 nm and about 690 nm are output from the first and second optical fibers, the setting of transmission and reflection characteristics of the reflective elements is important.

The laser light of a wavelength of about 630 nm from the first optical fiber and the laser light of a wavelength of about 690 nm from the second optical fiber are synthesized by using a wavelength synthesizer and radiated into a third optical fiber having a core with thulium ion (Tm³⁺) added thereto. The synthesized laser radiated into the third optical fiber is absorbed by the thulium ion (Tm³⁺) added to the core, and then, optical resonance takes due to reflective elements provided on both end faces of the third optical fiber to generate a blue laser light of a wavelength of about 450 nm.

Now, in the above-described fiber laser device, in order to increase the intensity of the laser light of a wavelength of about 450 nm, it is not sufficient only to increase the intensity of the laser lights of wavelengths of about 630 nm and about 690 nm output from the first and second optical fibers. In order to increase the intensity of the laser light of a wavelength of about 450 nm, it is required that the density (optical density) of the laser lights output from the first and second optical fibers be made large.

The reason is that, regarding the characteristics of fiber laser oscillation, there is the relation between the excitation light density per unit area in the fiber and the oscillation laser light density per unit area as shown in FIG. 2. In FIG. 2, the horizontal axis represents the excitation light density per unit area and the vertical axis represents the oscillation laser light density per unit area. When the excitation light density per unit area is small, laser light oscillation does not take place, but, when the excitation light density exceeds an oscillation threshold value, laser light oscillation takes place.

Furthermore, the conversion efficiency of excitation light to laser light is expressed by conversion efficiency =oscillation laser light density per unit area / excitation light density per unit area. The conversion efficiency can be increased by increasing the excitation light density per unit area. That is, when excitation light density is increased, even if excitation light has the same radiation intensity, the conversion efficiency is increased and the intensity of the oscillated laser light is increased.

On the other hand, in order to increase the intensity of oscillation laser light by increasing the light density per unit area of the excitation light to be radiated into an optical fiber, in the conventional fiber laser device, the infrared laser lights emitted from the first and second semiconductor lasers are made to be correctly radiated into the cores of the first and second optical fibers. However, when the infrared laser light is not correctly radiated into the core, the infrared laser light is not well propagated in the optical fiber and the absorption by the praseodymium ion (Pr³⁺) and ytterbium ion (Yb³⁺) added to the core is not fully performed, and then, theoscillated laser light intensity is decreased.

Because of this, it is required that the core diameter of the first and second optical fibers be set to be substantially equal to the spot diameters of the emitted infrared laser lights from the first and second semiconductor lasers. In order to make the spot diameter of the infrared laser light substantially equal to the core diameter of the optical fiber, an optical system composed of a lens, an optical waveguide, etc., is generally provided between the semiconductor laser and the optical fiber.

Furthermore, the spot diameters of lasers emitted from the first and second optical fibers are substantially equal to the core diameters of the first and second optical fibers. When the numerical aperture of the cores of the first and second optical fibers is equal to the numerical aperture of the third optical fiber, if the core diameters of the first and second optical fibers are not made equal to the core diameter of the third optical fiber, the excitation light enough to excite the thulium ion (Tm³⁺) added to the core of the third optical fiber cannot be radiated. Accordingly, when the excitation laser light is not sufficiently radiated, the thulium ion (Tm³⁺) added to the core of the third optical fiber cannot be sufficiently excited, and accordingly, there was a problem that the light density per unit area of the excitation light at the core of the third optical fiber is small.

Then, in order to increase the light density of the laser lights emitted from the first and second optical fibers for excitation in the third optical fiber, it is necessary to make the core diameters of the first and second optical fibers smaller than the core diameter of the third optical fiber. However, in order to increase the radiation efficiency of the infrared lights emitted from the first and second semiconductor lasers to the first and second optical fibers, it is required that the core diameters of the first and second optical fibers be substantially equal to or larger than the spot diameters at the incident end faces of the first and second optical fibers of the first and second semiconductor lasers. Therefore, the core diameters of the first and second optical fibers cannot be made smaller than the spot diameters of lasers to be radiated and the core diameter of the third optical fiber cannot be made smaller than the spot diameters at the incident end faces of the first and second fibers of the first and second semiconductor lasers. Accordingly, in the conventional fiber laser device, it was not able to obtain an excitation laser light of a high light density and obtain a high-output fiber laser.

### BRIEF SUMMARY OF THE INVENTION

It is an object of the present invention to provide a fiber laser device in which the radiation efficiency of a laser light emitted from a semiconductor element to an optical fiber is increased and a high-output laser light can be generated by increasing the light density per unit area of an excitation light emitted from an optical fiber.

A fiber laser device according to an aspect of the present invention comprises an excitation light source; a first optical fiber having a core with first rare-earth ions added thereto, a first clad covering the core, and a second clad provided around the first clad, having an optical resonator formed by arrangement of reflective elements at the end faces of the first optical fiber, and radiating a laser light in a first wavelength region generated by an excitation light emitted from the excitation light source; and a second optical fiber having a core with second rare-earth ions added thereto, having an optical resonator formed by arrangement of reflective elements at the end faces of the second optical fiber, having a laser light as an excitation light emitted from the first optical fiber, and radiating a laser light in a second wavelength region different from the first wavelength region.

A fiber laser device according to another aspect of the present invention also comprises an excitation light source; a first optical fiber having a core with first rare-earth ions added thereto, a first clad covering the core, and a second clad provided around the first clad, having an optical resonator formed by arrangement of reflective elements at the end faces of the first optical fiber, and radiating a laser light of a first wavelength region generated by an excitation light emitted from the excitation light source; a second optical fiber having a core with first rare-earth ions added thereto, a first clad covering the core, and a second clad provided around the first clad, having an optical resonator formed by arrangement of reflective elements at the end faces of the second optical fiber, and radiating a laser light of a second wavelength region generated by an excitation light emitted from the excitation light source; and a third optical fiber having a core with second rare-earth ion added thereto, having an optical resonator formed by arrangement of reflective elements at the end faces of the third optical fiber, having the laser lights as excitation lights emitted from the first and second optical fibers, and radiating a laser light of a third wavelength different from the first and second wavelengths.

The above and other objects, features and advantage of the invention will become more clearly understood from the following description referring to the accompanying drawing.

### BRIEF DESCRIPTION OF THE DRAWINGS

FIG. 1 is a block diagram showing the construction of a fiber laser device of an embodiment of the present invention;

FIG. 2 shows the relation between the excitation light density per unit area and the oscillation laser light density in the fiber laser device of an embodiment of the present invention; and

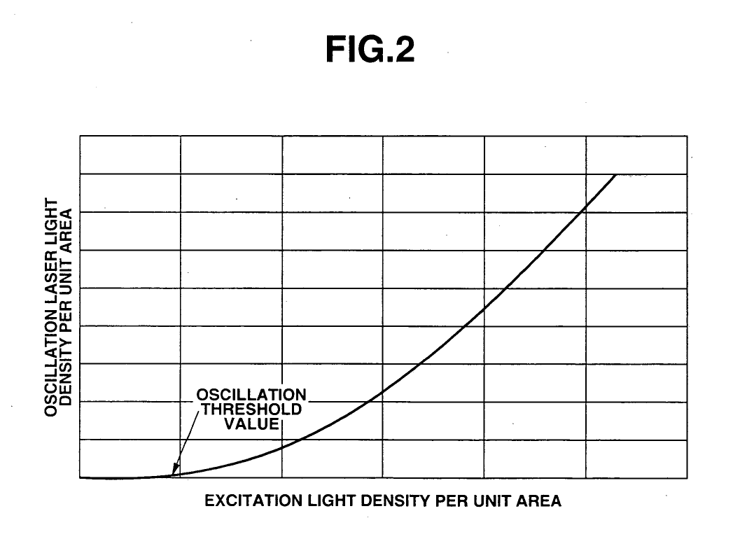

FIG. 3 is a block diagram showing a projection-type image display device in which the fiber laser device of an embodiment of the present invention is used as a light source.

### DETAILED DESCRIPTION OF THE INVENTION

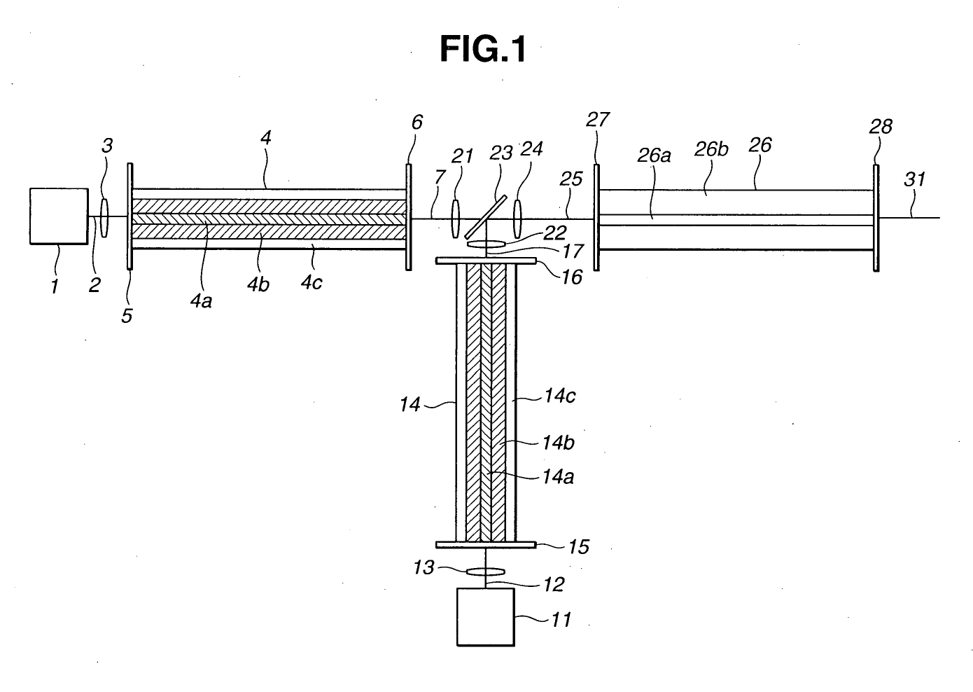

Hereinafter, the embodiments of the present invention are described in detail with reference to the drawings. The construction of a fiber laser device according to an embodiment of the present invention is described using FIG. 1. Reference numeral 1 in the drawing represents a first semiconductor laser element which outputs an infrared laser light 2 of a wavelength of 835 nm, for example. The infrared laser light 2 of a wavelength of 835 nm emitted by the first semiconductor laser element 1 is condensed by a condensing lens 3 and radiated onto the incident end face of a first optical fiber 4.

The first optical fiber 4 is a double-clad fiber composed of a two-layer clad having a core 4a in which rare-earth ions of praseodymium ion (Pr³⁺) and ytterbium ion (Yb³⁺) are added, a first clad 4b provided around the core 4a, and a second clad 4c provided around the first clad 4b.

The infrared laser light 2 of a wavelength of 835 nm from the first semiconductor laser element 1 is condensed by the condensing lens 3 so as to be substantially the same in diameter as the first clad. The infrared laser light 2 condensed by the condensing lens 3 is radiated into the first optical fiber 4 and propagated in the first clad 4b and core 4a. The first optical fiber 4 is set such that, when the refractive indices of the core 4a, first clad 4b, and second clad 4c are na, nb, and nc, the refractive indices satisfy the relation of na>nb>nc.

The infrared laser light 2 radiated into the first optical fiber 4 is absorbed by the praseodymium ion (Pr³⁺) and ytterbium ion (Yb³⁺) added to the core 4a to excite the praseodymium ion (Pr³⁺) and ytterbium ion (Yb³⁺) while the infrared laser light 2 is propagated in the core 4a and first clad 4b. The praseodymium ion (Pr³⁺) and ytterbium ion (Yb³⁺) added to the core 4a generate a light of a wavelength of about 630 nm close to a first wavelength when the praseodymium ion (Pr³⁺) and ytterbium ion (Yb³⁺) in an excitation state relax.

In the first optical fiber 4, an optical resonator is formed such that a reflective element 5 is provided at the incident end and a reflective element 6 is provided at the radiant end. The reflective elements 5 and 6 are composed of, for example, dielectric mirrors and a light of a wavelength of about 630 nm is amplified by a stimulated emission to generate a laser oscillation.

In the first optical fiber 4, a laser light 7 of a wavelength of about 630 nm is emitted from the radiant end face of the core 4a such that, in the reflective element 5 at the incident end, the reflectance of the light of a wavelength of about 630 nm is set to be substantially 100% and that, in the reflective element 6 at the radiant end, the reflectance of the light of a wavelength of about 630 nm is set to be lower than 100%.

Moreover, the light of a wavelength of 835 nm emitted from the first semiconductor laser 1 is absorbed by the praseodymium ion (Pr³⁺) and ytterbium ion (Yb³⁺) while propagated in the first optical fiber 4, but there is some of the light reaching the reflective element 6 without being absorbed by the praseodymium ion (Pr³⁺) and ytterbium ion (Yb³⁺). The light reaching the reflective element 6 without being absorbed by the praseodymium ion (Pr³⁺) and ytterbium ion (Yb³⁺) and passing through the reflective element 6 is not effectively used. Accordingly, it is desirable that, in the reflective element 6, the reflectance of the light of a wavelength of about 835 nm be increased.

Reference numeral 11 in the drawing represents a second semiconductor element which outputs an infrared laser light 12 of a wavelength of 835 nm, for example. The infrared laser light 12 of a wavelength of 835 nm emitted from the second semiconductor element 11 is condensed by a condensing lens 13 and radiated onto the incident end face of a second optical fiber 14.

The second optical fiber 14 is a double-clad fiber composed of a two-layer clad having a core 14a in which rare-earth ions of praseodymium ion (Pr³⁺) and ytterbium ion (Yb³⁺) are added, a first clad 14b provided around the core 14a, and a second clad 4c provided around the first clad 14b.

The infrared laser light 12 of a wavelength of 835 nm from the second semiconductor laser element 11 is condensed by the condensing lens 13 so as to be substantially the same in diameter as the first clad 14b. The infrared laser light 12 condensed by the condensing lens 13 is radiated into the first optical fiber 14 and propagated in the first clad 14b and core 14a. The second optical fiber 14 is set such that, when the refractive indices of the core 14a, first clad 14b, and second clad 14c are Na, Nb, and Nc, the refractive indices satisfy the relation of Na>Nb>Nc.

The infrared laser light 12 radiated into the second optical fiber 14 is absorbed by the praseodymium ion (Pr³⁺) and ytterbium ion (Yb³⁺) added to the core 14a to excite the praseodymium ion (Pr³⁺) and ytterbium ion (Yb³⁺) while the infrared laser light 12 is propagated in the core 14a and first clad 14b. The praseodymium ion (Pr³⁺) and ytterbium ion (Yb³⁺) added to the core 14a generate a light of a wavelength of about 690 nm close to a second wavelength when relaxation of the praseodymium ion (Pr³⁺) and ytterbium ion (Yb³⁺) in an excitation state takes place.

In the second optical fiber 14, an optical resonator is formed such that a reflective element 15 is provided at the incident end and a reflective element 16 is provided at the radiant end. The reflective elements 15 and 16 are composed of, for example, dielectric mirrors and a light of a wavelength of about 690 nm is amplified by a stimulated emission to generate a laser oscillation.

In the second optical fiber 14, a laser light 17 of a wavelength of about 690 nm is emitted from the radiant end face of the core 14a of the second optical fiber 14 such that, in the reflective element 15 at the incident end, the reflectance of the light of a wavelength of about 690 nm is set to be substantially 100% and that, in the reflective element 16 at the radiant end, the reflectance of the light of a wavelength of about 690 nm is set to be lower than 100%.

Moreover, the light of a wavelength of 835 nm emitted from the second semiconductor laser 11 is absorbed by the praseodymium ion (Pr³⁺) and ytterbium ion (Yb³⁺) while propagated in the first optical fiber 14, but there is some of the light reaching the reflective element 16 without being absorbed by the praseodymium ion (Pr³⁺) and ytterbium ion (Yb³⁺). The light reaching the reflective element 16 without being absorbed by the praseodymium ion (Pr³⁺) and ytterbium ion (Yb³⁺) and passing through the reflective element 16 is not effectively used. Accordingly, it is desirable that, in the reflective element 16, the reflectance of the light of a wavelength of about 835 nm be increased.

The laser light 7 of a wavelength of about 630 nm emitted from the first optical fiber 4 is collimated by a collimating lens 21 and radiated onto the dielectric mirror 23. Furthermore, the laser light 17 of a wavelength of about 690 nm emitted from the second optical fiber 14 is collimated by a collimating lens 22 and radiated onto the dielectric mirror 23. The dielectric mirror 23 makes the laser light 7 of a wavelength of about 630 nm collimated by the collimating lens 21 pass through, and the laser light 17 of a wavelength of about 690 nm collimated by the collimating lens 22 is reflected by the dielectric mirror 23. The laser light 7 of a wavelength of about 630 nm passed through the dielectric mirror 23 and the laser light 17 of a wavelength of about 690 nm reflected on the dielectric mirror 23 are synthesized on the same optical axis to radiate a laser light 25. The synthesized laser light 25 from the dielectric mirror 23 is condensed by a condensing lens 24 and radiated into a third optical fiber 26.

That is, the collimating lenses 21 and 22, the dielectric mirror 23, and the condensing lens 24 constitute an optical coupling portion which makes the laser lights 7 and 17 from the first and second optical fibers 4 and 14 radiated into the third optical fiber 26.

The third optical fiber 26 is a single-clad fiber composed of a core 26a having a rare-earth ion of thulium ion (Tm³⁺) added thereto and a clad 26b provided around the core 26a. In the third optical fiber 26, a reflective element 27 is provided at the incident end and a reflective element 28 is provided at the radiant end to form an optical resonator. The reflective elements 27 and 28 are composed of dielectric mirrors, for example.

The synthesized laser light 25 of the laser light 7 of a wavelength of about 630 nm from the first optical fiber 4 and the laser light 17 of a wavelength of about 690 nm from the second optical fiber 14 is radiated into the third optical fiber 26 and propagated in the core 26a. While the synthesized laser light 25 is propagated in the core 26a, the laser light 7 of a wavelength of about 630 nm and the laser light 17 of a wavelength of about 690 nm in the synthesized laser light 25 are absorbed in the thulium ion (Tm³⁺) added to the core 26a and excite the thulium ion (Tm³⁺). The thulium ion (Tm³⁺) added to the core 26a generates a laser light of a wavelength of about 450 nm when the thulium ion (Tm³⁺) in an excitation state relax.

In the third optical fiber 26, the reflectance of the laser light of a wavelength of about 450 nm of the reflective element 27 at the incident end is set to be substantially 100% and the reflectance of the laser light of a wavelength of about 450 nm of the reflective element 28 at the radiant end is set to be less than 100%. In the third optical fiber 26, the laser light of a wavelength of about 450 nm is amplified by a stimulated emission to cause a laser oscillation. The third optical fiber 26 radiates a laser light 31 of a wavelength of about 450 nm from the radiant end of the core 26a.

The synthesized laser light 25 of the laser light 7 of a wavelength of about 630 nm and the laser light 17 of a wavelength of about 690 nm is absorbed in the thulium ion (Tm³⁺) added to the core 26a, while propagated in the third optical fiber 26, but there is some laser light reaching the reflective element 28 without being absorbed by the thulium ion (Tm³⁺). The laser light reaching the reflective element 28 without being absorbed by the thulium ion (Tm³⁺) and passing through the reflective element 28 is not effectively used. Therefore, it is desirable that, in the reflective element 28, the reflectances of the laser lights of wavelengths of about 630 nm and about 690 nm be increased.

In the fiber laser device having such a construction, the laser diameter and spread angle at the radiant end of the first optical fiber 4 of the laser light 7 of a wavelength of about 630 nm emitted from the core 4a of the first optical fiber 4 are controlled by the diameter of the core 4a and the numerical aperture of the core determined by the core 4a and the refractive indices na and nb of the core 4a and first clad 4b . Furthermore, the product of the laser diameter and the spread angle (sin) of the laser light 7 of a wavelength of about 630 nm emitted from the core 4a of the first optical fiber 4 is constant. Accordingly, the product of the diameter and the numerical aperture of the core 26a of the third optical fiber 26 is made equal to or larger than the product of the core diameter and the numerical aperture of the core 4a of the first optical fiber 4. In this way, substantially the whole of the laser light 7 of a wavelength of about 630 nm emitted from the first optical fiber 4 can be radiated into the core 26a of the third optical fiber 26.

When a single-clad fiber is used as the first optical fiber 4 as in the conventional fiber laser device, in order to radiate an excitation infrared laser into the single-clad fiber with a high efficiency, it is necessary that the spot diameter at the incident end of the single-clad fiber of the excitation infrared laser be the same as or smaller than the core diameter. Furthermore, the spot diameter at the radiant end of the single-clad fiber of the laser light of a wavelength of about 630 nm emitted from the single-clad fiber is substantially equal to the core diameter of the single-clad fiber. Accordingly, the spot diameter at the radiant end of the single-clad fiber of the laser light of a wavelength of about 630 nm emitted from the single-clad fiber is equal to or larger than the spot diameter at the incident end of the single-clad fiber of the excitation infrared laser.

As in the fiber laser device of an embodiment of the present invention, a double-clad fiber is used for the first optical fiber 4, the spot diameter at the incident end of the double-clad fiber of an excitation infrared laser is made substantially equal to the diameter of the first clad 4b and the excitation infrared laser is propagated in the first clad 4b and absorbed in the core 4a inside the first clad 4b . Therefore, the spot diameter of the laser light of a wavelength of about 630 nm can be reduced.

That is, the core 4a of the first optical fiber 4 is provided inside the first clad 4b and the diameter of the first clad 4b is made equal to the spot diameter at the incident end of the first optical fiber 4 of the infrared laser light 2 from the semiconductor laser element 1. That is, the diameter of the core 4a can be made smaller than the diameter of the first clad 4b . Because of this, the spot diameter at the radiant end of the first optical fiber 4 of the laser light 7 of a wavelength of about 630 nm generated by the praseodymium ion (Pr³⁺) and ytterbium ion (Yb³⁺) added to the core 4a can be made smaller than the spot diameter at the incident end of the first optical fiber of the infrared laser light 2.

In the same way, the core 14a of the second optical fiber 14 is provided inside the first clad 14b and the diameter of the first clad 14b is made equal to the spot diameter at the incident end of the second optical fiber 14 of the infrared laser light 2 from the semiconductor laser element 11. That is, the diameter of the core 14a can be made smaller than the diameter of the first clad 14b. Because of this, the spot diameter at the radiant end of the second optical fiber 14 of the laser light 17 of a wavelength of about 690 nm generated by the praseodymium ion (Pr³⁺) and ytterbium ion (Yb³⁺) added to the core 14a can be made smaller than the spot diameter at the incident end of the second optical fiber 14 of the infrared laser light 12.

On the other hand, the diameter of the core 26a of the third optical fiber 26 is made equal to or larger than the spot diameter at the incident end of the third optical fiber 26 of the synthesized laser light 25 from the dielectric mirror 23. Thus, substantially the whole of the laser lights 7 and 17 from the first and second optical fibers 4 and 14 can be radiated into the third optical fiber 26.

As described above, in the fiber laser device of an embodiment of the present invention, since an optical fiber having a double-clad structure is used in the first and second optical fibers 4 and 14, the diameter of the cores 4a and 14a of the first and second optical fibers 4 and 14 can be made smaller than the diameter of the first clads 4b and 14b. Therefore, the spot diameter of the laser lights of wavelengths of about 630 nm and about 690 nm can be reduced.

Furthermore, with the reduced diameter of the cores 4a and 14a of the first and second optical fibers 4 and 14, the diameter of the core 26a of the third optical fiber 26 can be reduced. Therefore, the light density of the laser lights of wavelengths of about 630 nm and 690 nm can be increased to obtain a high-output laser light 31 of a wavelength of about 450 nm.

In the above description, as an example, the case where a laser light 7 of a wavelength of about 630 nm is output from the first optical fiber 4 and a laser light 17 of a wavelength of about 690 nm is output from the second optical fiber 14 was described, but an arrangement is also possible so as to output laser lights of two wavelengths by using either of the optical fibers. That is, simultaneous laser oscillation at wavelengths of about 630 nm and 690 nm can be realized such that characteristics of the praseodymium ion (Pr³⁺) and ytterbium ion (Yb³⁺) added to the core and the reflective elements on the incident and radiant sides are set, and the red laser lights 7 and 17 of two wavelengths in the wavelength region can be emitted from one optical fiber.

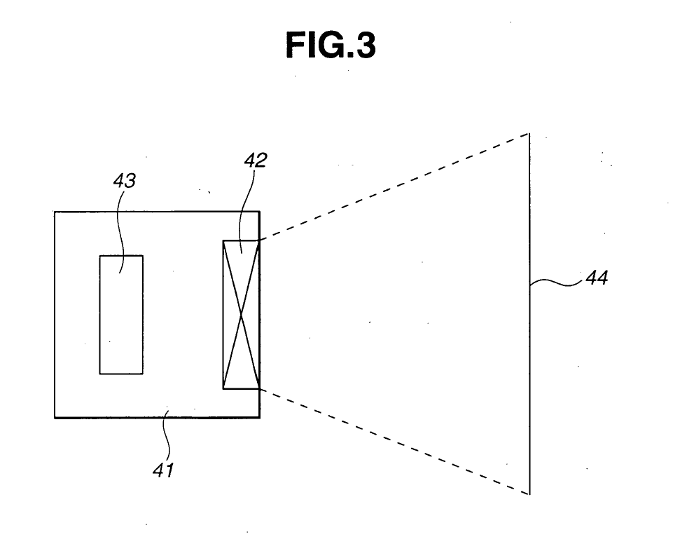

Furthermore, as shown in FIG. 3, the blue laser light 31 of a wavelength of about 450 nm output from the third optical fiber 26 of the fiber laser device of an embodiment of the present invention can be used as the blue light source of a projection-type image display device 41. The projection-type image display device 41 contains a light bulb 42 on which an image is displayed by a video signal from a signal processing circuit (not illustrated) and a light source 43 for projecting the three primary colors of red, green, and blue to the light bulb 42, and an image is enlarged and projected on a screen 44 by a light from the light source 43 passing through the light bulb 42. When the blue laser light 31 of a wavelength of about 450 nm generated by the fiber laser device of an embodiment of the present invention is used as the blue light source in the light source 42 of the projection-type image display device 41, the reproducibility of the projected image on the screen is improved.

In the fiber laser device of an embodiment of the present invention, an excitation red light projected from a semiconductor laser element is propagated to the first clad in the double-clad fiber and absorbed in the core in which rare-earth ions are added, a laser light of a small spot diameter is output, and, by using the laser light, a laser light having a different wavelength (for example, a blue laser light) of a high output can be output.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A fiber laser device comprising:
an excitation light source;
a first optical fiber having a core with first rare-earth ions added thereto, a first clad covering the core, and a second clad provided around the first clad, having an optical resonator formed by arrangement of reflective elements at the end faces of the first optical fiber, and radiating a laser light in a first wavelength region generated by an excitation light emitted from the excitation light source; and
a second optical fiber having a core with second rare-earth ions added thereto, having an optical resonator formed by arrangement of reflective elements at the end faces of the second optical fiber, having a laser light as an excitation light emitted from the first optical fiber, and radiating a laser light in a second wavelength region different from the first wavelength region.

2. A fiber laser device as claimed in claim 1, wherein, in the first optical fiber, optical resonance is performed inside the core with the first rare-earth ions added thereto to radiate laser lights of two wavelengths in the first wavelength region.

3. A fiber laser device as claimed in claim 1, wherein the rare-earth ions added to the core of the first optical fiber are praseodymium ion (Pr³⁺) and ytterbium ion (Yb³⁺) and laser lights of wavelengths of about 630 and about 690 nm in the first wavelength region are radiated while the radiated infrared laser lights function as excitation lights.

4. A fiber laser device as claimed in claim 1, wherein the diameter of the first clad of the first optical fiber is substantially equal to the spot diameter at the end face of the first optical fiber of an excitation light from the excitation light source.

5. A fiber laser device as claimed in claim 1, wherein the product of the core diameter and the numeric aperture in the second optical fiber is set to be equal to or larger than the product of the core diameter and the numeric aperture in the first optical fiber.

6. A fiber laser device comprising:
an excitation light source;
a first optical fiber having a core with first rare-earth ions added thereto, a first clad covering the core, and a second clad provided around the first clad, having an optical resonator formed by arrangement of reflective elements at the end faces of the first optical fiber, and radiating a laser light of a first wavelength region generated by an excitation light emitted from the excitation light source;
a second optical fiber having a core with first rare-earth ions added thereto, a first clad covering the core, and a second clad provided around the first clad, having an optical resonator formed by arrangement of reflective elements at the end faces of the second optical fiber, and radiating a laser light of a second wavelength region generated by an excitation light emitted from the excitation light source; and
a third optical fiber having a core with a second rare-earth ion added thereto, having an optical resonator formed by arrangement of reflective elements at the end faces of the third optical fiber, having the laser lights as excitation lights emitted from the first and second optical fibers, and radiating a laser light of a third wavelength different from the first and second wavelengths.

7. A fiber laser device as claimed in claim 6, wherein the first rare-earth ions added to the core of the first optical fiber are praseodymium ion (Pr³⁺) and ytterbium ion (Yb³⁺) and a laser light of an wavelength of about 630 nm in the first wavelength region is radiated while the radiated infrared laser light functions as an excitation light, and wherein the first rare-earth ions added to the core of the second optical fiber are praseodymium ion (Pr³⁺) and ytterbium ion (Yb³⁺) and a laser light of an wavelength of about 690 nm in the second wavelength region is radiated while the radiated infrared laser light functions as an excitation light

8. A fiber laser device as claimed in claim 6, further comprising an optical coupling portion in which the laser lights emitted from the first and second optical fibers are coupled to output the laser lights on one axis and to radiate the laser lights as excitation lights into the third optical fiber.

9. A fiber laser device as claimed in claim 6, wherein the diameters of the first clads provided in the first and second optical fibers are substantially equal to the spot diameters of the excitation lights from the excitation light sources at the end faces of the first and second optical fibers.

10. A fiber laser device as claimed in claim 6, wherein the product of the core diameter and the numerical aperture in the third optical fiber are set to be equal to or larger than the product of the core diameter and the numerical aperture in each of the first and second optical fibers.

11. A fiber laser device comprising:
an excitation light source generating an infrared excitation light;
a first optical fiber having a core with praseodymium ion (Pr³⁺) and ytterbium ion (Yb³⁺) added thereto, a first clad covering the core, and a second clad provided around the first clad, having an optical resonator formed by arrangement of reflective elements at the end faces of the first optical fiber, and radiating a laser light of a wavelength of about 630 nm region generated by an excitation light emitted from the excitation light source;
a second optical fiber having a core with praseodymium ion (Pr³⁺) and ytterbium ion (Yb³⁺) added thereto, a first clad covering the core, and a second clad provided around the first clad, having an optical resonator formed by arrangement of reflective elements at the end faces of the second optical fiber, and radiating a laser light of a wavelength of about 690 nm region generated by an excitation light emitted from the excitation light source; and
a third optical fiber having a core with thulium ion (Tm³⁺) added thereto, having an optical resonator formed by arrangement of reflective elements at the end faces of the third optical fiber, having the laser lights of wavelengths of about 630 nm and about 690 nm as excitation lights emitted from the first and second optical fibers, and radiating a blue laser light of a wavelength of about 450 nm.

12. A projection-type image display device in which a light close to a third wavelength of 450 nm output from the third optical fiber in a fiber laser device as claimed in claim 11 is used as a blue light source.
